(19) United States
(12) Patent Application Publication
(10) Pub. No.: US 2013/0218914 A1
(43) Pub. Date: Aug. 22, 2013

(54) SYSTEM AND METHOD FOR PROVIDING RECOMMENDATIONS BASED ON INFORMATION EXTRACTED FROM REVIEWERS' COMMENTS

(71) Applicants: Anna Stavrianou, Grenoble (FR); Caroline Brun, Grenoble (FR)

(72) Inventors: Anna Stavrianou, Grenoble (FR); Caroline Brun, Grenoble (FR)

(73) Assignee: Xerox Corporation, Norwalk, CT (US)

(21) Appl. No.: 13/400,263

(22) Filed: Feb. 20, 2012

(51) Int. Cl. G06F 17/30

(52) U.S. Cl. 707/755; 707/E17.058

(57) ABSTRACT

A recommendation method includes receiving a user's review of an item that includes a textual comment. Deficient features of the reviewed item are identified from the text by applying a set of extraction patterns. Each pattern is satisfied when a term in the text, which is associated in a structured terminology with one of a predefined set of features, is in a syntactic relation with another term in the text, such as a polar adjective or expression of a wish or a lack. When such a pattern is satisfied, the corresponding feature is considered a deficient feature. Feature attributes of the reviewed item are compared with corresponding feature attributes of a set of items to identify any improved items whose attribute for the deficient feature is better than that for the reviewed item. The improved item or items can be recommended to the user or to others reading the review.

### BACKGROUND

The exemplary embodiment relates to information extraction. It finds particular application in connection with an apparatus and method for generating recommendations for new items based on opinions of other items.

Recommender systems attempt to recommend items to a user based on prior information. The aim of recommender systems is to reduce the space of items that may be of interest to a specific user. See, for example, Adomavicius and Tuzhilin, “Towards the next generation of recommender systems: a survey of the state-of-the-art and possible extensions,” IEEE Transactions on Knowledge and Data Engineering, 17(6):734-749 (2005).

The items recommended often depend on the context and may include, for example, movies, products, books, travel suggestions, news images, web pages, social contacts, and the like. Typically, a recommender system compares a user's profile with a set of reference characteristics and seeks to predict the rating or preference that a user would give to an item that they have not yet considered. These characteristics may be derived from the item (a content-based approach) or the user's social environment (a collaborative filtering approach).

In content-based approaches, the system calculates the similarity between two items. These systems are based on the assumption that if a user has shown interest in item A, the user is likely to be interested in the item i for which the similarity sim (i, A) is relatively high. In collaborative approaches, the system calculates the similarity between two users. These systems are based on the assumption that if two users have something in common (e.g., the same demographic characteristics and/or, the same already declared preferences), they are likely to be interested in the same items. Hybrid approaches use a combination of the content-based and collaborative approaches.

Product reviews have been used to obtain users' ratings for certain products. This information could be used for recommendation purposes. However, such a method would not consider what aspects of the product have resulted in the rating. As a result, the recommendation may be of limited value. For example, a user may give a poor rating to a product because it does not have a particular feature that he or she needs and which was expected to be present. A recommendation for a similar product may not be useful if the recommended product also lacks the feature.

The exemplary system and method enable recommendations for a different item to be generated from a user's explicit suggestions or opinions about a reviewed item.

### INCORPORATION BY REFERENCE

The following references, the disclosures of which are incorporated herein by reference in their entireties, are mentioned:
U.S. application Ser. No. 13/052,774, filed on Mar. 21, 2011, entitled CUSTOMER REVIEW AUTHORING ASSISTANT, by Caroline Brun.
U.S. application Ser. No. 13/052,686, filed on Mar. 21, 2011, entitled CORPUS-BASED SYSTEM AND METHOD FOR ACQUIRING POLAR ADJECTIVES, by Caroline Brun.
U.S. application Ser. No. 13/272,553, filed on Oct. 13, 2011, entitled SYSTEM AND METHOD FOR SUGGESTION MINING, by Caroline Brun and Caroline Hagège.
Caroline Brun, “Detecting Opinions Using Deep Syntactic Analysis,” Proc. Recent Advances in Natural Language Processing (RANLP), Hissar, Bulgaria (2011).

The following references disclose a parser for syntactically analyzing an input text string in which the parser applies a plurality of rules which describe syntactic properties of the language of the input text string: U.S. Pat. No. 7,058,567, issued Jun. 6, 2006, entitled NATURAL LANGUAGE PARSER, by Aït-Mokhtar, et al., and Aït-Mokhtar, et al., “Robustness beyond Shallowness: Incremental Dependency Parsing,” Special Issue of NLE Journal (2002); Aït-Mokhtar, et al., “Incremental Finite-State Parsing,” in Proc. 5th Conf. on Applied Natural Language Processing (ANLP'97), pp. 72-79 (1997), and Aït-Mokhtar, et al., “Subject and Object Dependency Extraction Using Finite-State Transducers,” in Proc. 35th Conf. of the Association for Computational Linguistics (ACL'97) Workshop on Information Extraction and the Building of Lexical Semantic Resources for NLP Applications, pp. 71-77 (1997).

### BRIEF DESCRIPTION

In accordance with one aspect of the exemplary embodiment, a method for generating recommendations includes receiving a user's review of an item which includes a textual comment, and applying a set of extraction patterns. Each of the extraction patterns is configured to identify a deficient feature of the item based on finding a specified syntactic relation between words of the textual comment. When a deficient feature is identified, the method includes identifying an attribute of each of a plurality of features of the reviewed item, the plurality of features including the identified deficient feature. The identified attributes of the reviewed item are compared with stored attributes for the plurality of features for items in a set of items. This enables identifying an improved item from the set of items which has an attribute for the deficient feature which is determined to be an improvement over the deficient feature's attribute for the reviewed item. A recommendation is generated for the identified improved item.

In another aspect, a system for generating recommendations includes a semantic extraction component configured to identify a deficient feature of a reviewed item from a textual comment in a user's review of the item using a set of extraction patterns. Each of the extraction patterns is configured for identifying a specified syntactic relation between words of the textual comment. A mapping component is configured to query an associated database with attributes of the reviewed item for identifying improved items. The associated database includes, for each of a set of items, attributes for each of a set of features, the set of features including the identified deficient feature. Each of the identified improved items has an attribute which is determined to be better, for the deficient feature, than the attribute of the reviewed item. A recommendation generator is configured to generate a recommendation for the identified improved item. A processor implements the semantic extraction component, mapping component, and the recommendation generator.

In another aspect, a method for generating recommendations includes receiving a user's review of an item which includes a textual comment. Extraction patterns are applied to the textual comment, each of the patterns being satisfied when a first term in a textual comment, the first term being associated in memory with one of a set of features, is in a syntactic relation with a second term in the textual comment, the second term including a term from a polar vocabulary or an expression of a wish or a lack. When one of the extraction patterns is satisfied, the associated feature is identified as being a deficient feature of the reviewed item. Feature attributes of the reviewed item are compared with feature attributes of items stored in a database to identify an item in the database for which the feature attribute for the feature identified as deficient in the item is an improvement. A recommendation is generated based on one of the identified improved items.

### BRIEF DESCRIPTION OF THE DRAWINGS

FIG. 1 is an overview of system and method for generating recommendations;

FIG. 2 schematically illustrates a user review and a recommendation based thereon;

FIG. 3 is a functional block diagram illustrating a system for generating recommendations in an operating environment in accordance with one aspect of the exemplary embodiment; and

FIG. 4 is a flow diagram illustrating a method for generating recommendations in accordance with another aspect of the exemplary embodiment.

### DETAILED DESCRIPTION

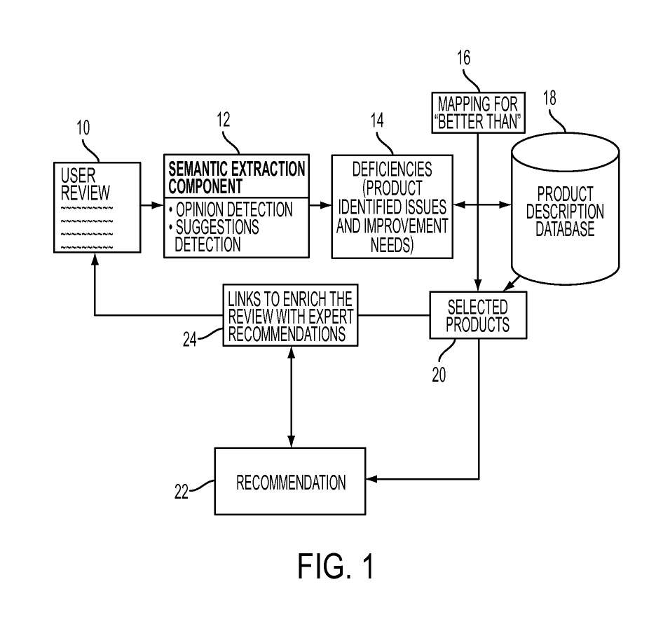

With reference to FIG. 1, an overview of an exemplary system and method for generating a recommendation is shown. Briefly, a user review 10 of an item, such as a product or a service, is received and processed by a semantic extraction component 12 to identify explicitly/implicitly expressed feature deficiencies 14 which can be linked to one or more components of the item, or to the item as a whole. The feature deficiencies 14 can be expressed in the form of an opinion or as a suggestion for improvement. A mapping 16 is generated between the features of the item for which deficiencies have been identified and features of a set of items stored in an item description database 18. The mapping identifies one or more items 20 which are similar, in their feature attributes, to the reviewed item, but have feature attributes which are better than those for the features identified as being deficient. A recommendation 22 is automatically generated and presented to the user and/or associated with the review for later access by others, e.g., as a link 24 to a webpage describing the improved item 20.

As used herein, a “user” can be any person who generates and/or submits a review of an item, irrespective of whether they have purchased, owned, or used the item, although in many cases they may have done so.

The user review 10 can be submitted to an opinions website or website of a company marketing the items. The items reviewed by the user and/or recommended by the system may include non-transitory and transitory products and services including devices, movies, books, travel suggestions, news images, web pages, social contacts, and the like. While in the examples below, electromechanical devices, such as printers, are the exemplified products, it is to be appreciated that any type of item for which a set of features can be expressed as respective attribute values or otherwise quantized can be considered.

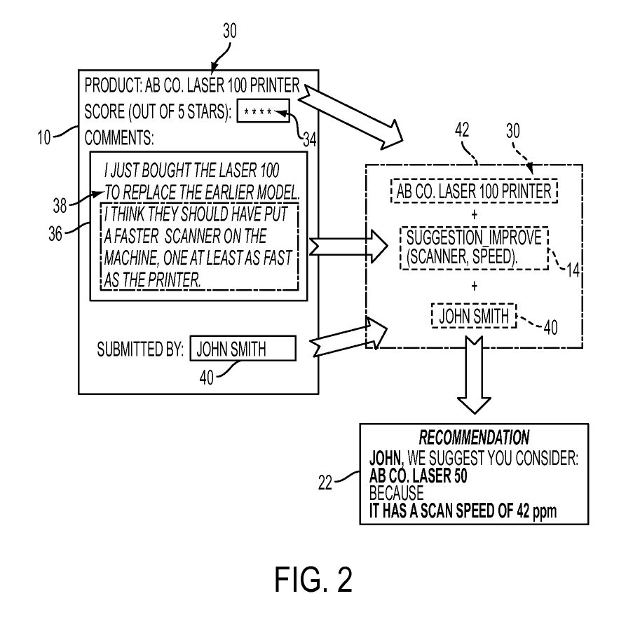

As shown in FIG. 2, an exemplary user review 10 which may be processed by the system is shown. The review may be received in electronic form, e.g., as an XML or other markup language file, Word or other text document, PDF document, or the like. The review 10 includes an identifier 30 which identifies the reviewed item, e.g., as visible text and/or as metadata of the digital document. In some embodiments, the review 10 may include a rating 34 that the user has given for the item, such as a score or an explicit recommendation. A comments field 36 is provided for the user to write his or her explicit textual comments 38 on the reviewed item. The textual comments can thus include free text in a natural language, such as English or French, with an appropriate grammar. The text 38 may include one or more text strings, such as sentences, each string including a sequence of tokens, such as words, punctuation, and other tokens, which may have been generated using a finite character set, referred to as an alphabet. In general, the reviewer is not limited to what is written in the comments field, other than, for example, a limit on the number of words/characters. In some cases, the free text 38 may be partially structured, for example, the user enters the positive opinions of the item being reviewed in a field specified as “pros” and the negative opinions of the item being reviewed in a field specified as “cons.” In some embodiments, this information (i.e., that the user considers the comment(s) to be positive or negative) may be used in the generation of the recommendation 22.

The review 10 also may identify the reviewer, such as with a user name field 40, in the form of metadata, by IP address, combination thereof, or the like. Information 42 extracted from the review 10 may include the item identifier 30, the reviewer identifier 40, and one or more feature deficiencies 14. The feature deficiencies 14 identify a feature which is the subject of the deficiency, which may include a component of the item (“scanner”, in FIG. 2) and/or its feature (“speed”, in FIG. 2) or simply refer to the item as a whole. The feature deficiency may also identify whether the system has tagged the feature deficiency as a suggestion for improvement (SUGGESTION_IMPROVE) or an opinion and, if an opinion, whether it is a negative opinion (OPINION_NEGATIVE). In some embodiments, the system does not utilize positive opinions (OPINION_POSITIVE) in forming the recommendation, in which case, text annotated as a positive opinion may be ignored, or may be used to identify features of the item whose attributes should be maintained in the recommended items.

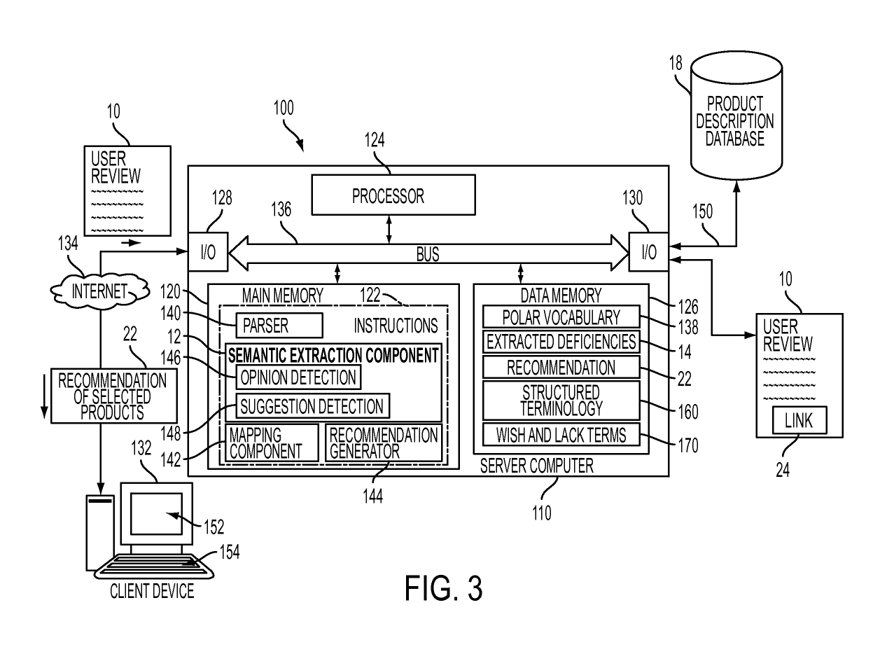

FIG. 3 illustrates one embodiment of a system 100 for generating recommendations 22. The system 100 receives a user review 10, submitted by a reviewer, and generates a recommendation 22, based on the review, for presenting to the reviewer submitting the review. The system 100 includes one or more computing device(s), such as the illustrated server computer 110. The computer 110 includes main memory 120, which stores instructions 122 for performing the exemplary method disclosed herein, and a processor 124, in communication with memory 120, for executing the instructions. Data memory 126 stores a review 10 during processing. One or more input/output devices 128, 130 allow the system to communicate with external devices, such as a client device 132, via a wired or wireless link, such as a local area network or a wide area network 134, such as the Internet. Hardware components 120, 124, 126, 128, 130 of the system 100 may communicate via a data/control bus 136.

Data memory 126 may also store a polar vocabulary 138 comprising a set of polar words/phrases, as well as information 40 extracted from the review including the extracted deficiencies 14, and a generated recommendation 22.

Main memory 120 stores a linguistic parser 140 for linguistically processing the text content 38 of the review 10, as well as the semantic extraction component 12, a mapping component 142 for generating the mapping 16, and a recommendation generator 144, which generates the recommendation based on the mapping. Each of the components 12, 140, 142, 144 may be software components implemented by computer processor 124 and are best understood in terms of the exemplary method described below.

The semantic extraction component 12 may be in the form of grammar rules written on top of conventional parser rules forming the parser 140, such as grammar rules for detection of opinions and/or grammar rules for detection of suggestions in the parsed text, illustrated as an opinion detection component 146 and a suggestion detection component 148. The detection of opinions makes use of the polar vocabulary 128 (primarily adjectives) and may be performed using the methods described in copending application Ser. Nos. 13/052,774 and 13/052,686, except as noted below. The detection of suggestions may be performed using the methods described in copending application Ser. No. 13/272,553, except as noted below.

The product description database 18 may be stored in local memory 110 or 120, and/or in a remote memory storage device accessible by a link 150, such as a wired or wireless link, such as a local area network or a wide area network, such as the Internet.

Memory 120 may also store a vocabulary generator (not shown) for generating all or part of the polar vocabulary 138, based on a corpus of reviews, as described in copending application Ser. Nos. 13/052,774 and 13/052,686.

The client device 132 may be a PC, laptop, tablet computer, smartphone, or the like, and includes components for implementing a graphical user interface. In particular, the client device is the form of a remote client computing device, which includes a display device 152, such as a computer monitor or LCD screen, for displaying the review 10 and recommendation 22 or link thereto, and a user input device 154, such as a keyboard, keypad, touch screen, cursor control device, or combination thereof, for inputting text to generate the review 10. The client device 132 may host a web browser for uploading the review 10 to a review site that is hosted by the server computer 110, or by a remote server computer (not shown) which is in communication with the server computer.

The various computers 110, 132, etc., may be similarly configured in terms of hardware, e.g., with a processor and memory, as for computer 110, and may communicate via wired or wireless links.

For example, a reviewer accesses the review website with the web browser on the client device 132 and uses the user input device 152 to generate a review 10 which may include entering, e.g., by typing, the text 38 in one or more predefined fields 36 of a review template, optionally, selecting a rating 34 from a predefined set of ratings or on a predefined scale for the item being reviewed. During input, the review 10 is displayed to the user on the display device 152 associated with the computer 132. Once the user is satisfied with the review, the user can submit it to the review website. The same review website 68 can be mined by the vocabulary generator for collecting many such submitted customer reviews 10 to form the review corpus.

The memory 120, 126 may be separate or combined and may represent any type of non-transitory computer-readable medium, such as random access memory (RAM), read only memory (ROM), magnetic disk or tape, optical disk, flash memory, or holographic memory. In one embodiment, the memory 120, 126 comprises a combination of random access memory and read only memory. In some embodiments, the processor 124 and memory 120 and/or 126 may be combined in a single chip. The I/O interface 128, 130 may comprise a modulator/demodulator (MODEM).

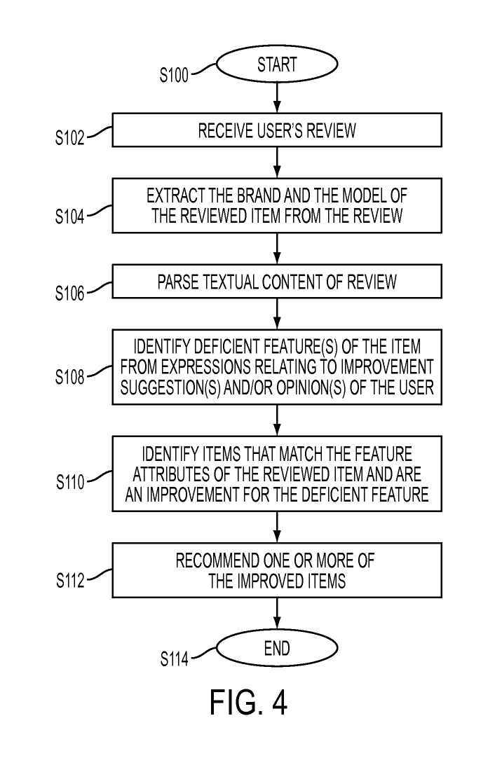

The digital processor 124 can be variously embodied, such as by a single-core processor, a dual-core processor (or more generally by a multiple-core processor), a digital processor and cooperating math coprocessor, a digital controller, or the like. The digital processor 124, in addition to controlling the operation of the computer 110, executes instructions stored in memory 120 for performing the method outlined in FIG. 4.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The exemplary system and method make use of opinions (see, for example, application Ser. Nos. 13/052,774 and 13/052,686) and suggestions (see, for example, application Ser. No. 13/272,553) which are automatically extracted from reviews to improve the recommender system. In some embodiments, the exemplary method may be used on top of standard recommender techniques to fine tune a recommendation 22 according to the user's comments. For example, the system could first apply a collaborative approach to identify products which the user may be interested in, for example which people in the reviewer's social network have rated highly, and then use the exemplary method to select from those products, or vice versa.

The exemplary system and method may employ a deep semantic analysis of the text 38, enabling the detection of opinions and suggestions within customer reviews about items, such as manufactured products, enabling detection of the weaknesses of the product or the potential improvements, according to the user's point of view. Then, this information is compared to the database 18 of items (e.g., products) containing attribute information for a set of product features, such as product characteristics, description, average price, etc. The information extracted from the reviews is used to select, within this database, one or more similar products that compensate for the problems or improvement needs identified within the review. Then, links to these products can be explicitly associated with a reviewer's review as “expert recommendations,” and can constitute an automatic enrichment of the review. An advantage for readers of these enriched reviews is that they can benefit from a contextualized recommendation that takes into account the semantic information conveyed in reviews from users of a given product, and to help other readers of the reviews in their product search. As an additional result, the reader of the review may be provided with a recommendation on a product that the reader did not know existed.

FIG. 3 illustrates the exemplary method, which can be performed with the apparatus of FIG. 1. The method begins at S100.

At S102, provision is made for a user to submit a review 10 on an item and the submitted review 10 is received by the system. The review 10 may be converted to a suitable form for processing, such as XML or HTML.

At S104, item identification information (e.g. identifier 30) is extracted from the review 10, such as the brand and/or manufacturer and/or the model of the reviewed product. This information often appears in a designated field, such as the title of the review, and is straightforward to extract. This information can later be used to identify respective attributes for each of a plurality of features for the item from the database 18, or other source of this information.

At S106, the text 38 of the review is extracted and parsed. In particular, the free text 38 is parsed by parser 140 to identify dependencies in the text which each express a syntactic relationship between words of the text, such as: subject-predicate relations; predicate-object relations, modifier-predicate relations, and the like. As will be appreciated, the exemplary method is not based on the simple co-occurrence of words in a sentence, but on the relations between pairs of text elements (words and phrases) which take into account the role of the text elements in the sentence and, in particular, with respect to each other.

At S108, feature deficiencies comprising improvement suggestion(s) and/or opinion(s) of the user expressed in the text (including identifying features and comparison words) are identified in the parsed text and stored in the feature deficiency list 14. This may include applying a set of extraction patterns (grammar rules) designed for identifying suggestions for improvement and/or opinions in the text and the specific feature (generally, fewer than all features) with which they are associated. This feature is then considered as a deficient feature.

Assuming that at S108, at least one feature deficiency has been extracted, then at S110 a comparison is made with items from the item database 18, based on the feature attributes of the item and identified feature deficiencies. The comparison aims to identify items that match the attributes of the reviewed product and yet which have better attributes for those features identified as deficient. If no feature deficiencies are extracted at S108, the method may terminate, or use other information to generate a recommendation.

At S112, a recommendation is generated, based on one or more of the improved items 20 identified at S110. The recommendation 22 may be output to the reviewer and/or may be linked to the review 10 in local or remote memory. If no improved items 20 are identified at S110, the method may terminate, or use other information to generate a recommendation.

The method ends at S114.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The method illustrated in FIG. 4 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 4, can be used to implement the method.

Further details of the system and method will now be described.

### Parsing Text (S106)

The parser 140 takes a text string, such as a sentence, paragraph, or even a sequence of a few words of the textual review 38 as input and breaks each sentence into a sequence of tokens (linguistic elements) and associates information with these tokens. The parser 140 provides this functionality by applying a set of rules, called a grammar, dedicated to a particular natural language such as French, English, or Japanese. The grammar is written in a formal rule language, and describes the word or phrase configurations that the parser tries to recognize. The basic rule set used to parse basic documents in French, English, or Japanese is called the “core grammar.” Through use of a graphical user interface, a grammarian can create new rules to add to such a core grammar. In some embodiments, the syntactic parser employs a variety of parsing techniques known as robust parsing, as disclosed for example in Salah Aït-Mokhtar, Jean-Pierre Chanod, and Claude Roux, “Robustness beyond shallowness: incremental dependency parsing,” in special issue of the NLE Journal (2002); above-mentioned U.S. Pat. No. 7,058,567; and Caroline Brun and Caroline Hagège, “Normalization and paraphrasing using symbolic methods” ACL: Second International workshop on Paraphrasing, Paraphrase Acquisition and Applications, Sapporo, Japan, Jul. 7-12, 2003.

In one embodiment, the syntactic parser 140 may be based on the Xerox Incremental Parser (XIP), which may have been enriched with additional processing rules to facilitate the extraction of the suggestions for improvement and opinions. Other natural language processing or parsing algorithms can alternatively be used.

The exemplary incremental parser 140 performs a pre-processing stage which handles tokenization, morphological analysis and part of speech (POS) tagging. Specifically, a preprocessing module of the parser breaks the input text into a sequence of tokens, each generally corresponding to a text element, such as a word, or to punctuation. Parts of speech are identified for the text elements, such as noun, verb, etc. Some tokens may be assigned more than one part of speech, and may later be disambiguated, based on contextual information. The tokens are tagged with the identified parts of speech.

A surface syntactic analysis stage performed by the parser includes chunking the input text to identify groups of words, such as noun phrases and adjectival terms (attributes and modifiers). Then, syntactic relations (dependencies) are extracted, in particular, the relations relevant to the exemplary suggestion extraction method.

Where reviews are expected to be in multiple languages, such as on a travel website, a language guesser (see, for example, in Gregory Grefenstette, “Comparing Two Language Identification Schemes,” Proc. 3rd Intern'l Conf. on the Statistical Analysis of Textual Data (JADT'95), Rome, Italy (1995) and U.S. application Ser. No. 13/037,450, filed Mar. 1, 2011, entitled LINGUISTICALLY ENHANCED EMAIL DETECTOR, by Caroline Brun, et al., the disclosure of which is incorporated herein by reference in its entirety) may be used to detect the main language of the review 10 and an appropriate parser 140 for that language is then employed.

As will be appreciated, while a full rule-based parser, such as the XIP parser, is exemplified, more simplified parsing systems for analyzing the text 38 are also contemplated which may focus on only those dependencies, etc., which are relevant to the extraction patterns.

In some embodiments, the parser may include a coreference module which identifies the noun which corresponds to a pronoun in a relation, by examining the surrounding text. For example, given a review which states:

I just bought the XXI printer. I wish it had a larger paper tray.

the pronoun “It” can be tagged by the coreference module of the parser to identify that it refers to the noun “printer,” allowing extraction of the syntactic relation between wish and printer, for example.

In some embodiments, the parser labels words in the text 38 which are associated with features of the type of product being reviewed. For example, a structured terminology 160 may be stored in memory which, for each of a set of feature classes, lists a set of related terms, such as synonyms and hyponyms. Each feature's list may thus include a finite set of two, three or more of these feature terms, each term including one or more words, and each list including a different set of terms. The exemplary structured terminology includes terms that are primarily nouns and noun phrases, i.e., does not include any verbs. In general the terms in the structured terminology are short, containing at a maximum, a few words. For example each term may be, in general, from 1 to 5 words in length, with fewer than 1 in 20 of the terms in the structured terminology being longer than 5 words in length. The structured terminology 160 is dedicated to the particular domain of the review, such as “printers.” For example, in the case of the feature “printer price,” the words for the class Printer Price that are stored in the terminology 160 may include a set of including “cost,” “price,” “expense”, and “money”. For the feature Scanner Speed, the terms “scanner speed”, “scan speed”, “pages per minute”, and so forth may be stored in this feature's class list. As will be appreciated, the terms may be encoded in the structured terminology as their root or lemma form, and/or using other rules which can identify the presence of terms in a review when the surface form shown in the review does not exactly match the stored form of the term.

A set of attribute terms, each of which relates positively or negatively to at least one of the features, may be stored in the polar vocabulary 138, together with an indication as to whether the attribute term is favorable or not favorable regarding the feature. In general, the attribute terms are adjectives. For example, for the feature “cost,” the attribute terms “expensive,” “costly,” “overpriced,” “high priced” may be listed as negative attributes, while “inexpensive,” “cheap,” “low priced”, may be listed as positive attributes. For the feature “scanner speed,” attribute terms such as “fast”, “slow”, “high speed”, and “low speed” may be stored as positive and negative attribute terms, respectively. For attribute terms that are favorable, when associated with one feature but are unfavorable when associated with another, the polar vocabulary may specify which features the attribute terms are favorable (positive) and for which they are unfavorable (negative). For extracting suggestions, a set of comparison terms, such as “cheaper,” “more,” “less,” “heavier,” “lighter,” “faster,” and so forth may be stored in memory and may be associated with respective one(s) of the features, as for the attribute terms.

In some embodiments, the labeling of attribute terms, feature terms, and comparison terms may be performed by the semantic extraction component 12.

### Extraction of Feature Deficiencies (S108)

A goal of this step is to identify the feature deficiencies 14, i.e., the weaknesses and the possible improvements mentioned in a review.

In general, a set of features is selected for the type of item under consideration. The feature set may include those features in which a user is typically most interested. The type of features selected for the set, which are used in creating the structured terminology 160 and for the extraction of deficient features, may thus depend on the type of item under consideration. The selected features in the set may also depend on the features for which attributes are available, e.g., in the database 18, or for which manufacturers have made that information available.

In order extract the opinion of a user about a given feature of a product with reasonable precision, the semantic extraction component 12 includes an opinion detection component 146, which is configured to perform feature-based opinion mining. The item (e.g., a product) is considered as having an associated predefined set of features (e.g., quality, print speed, and resolution in the case of a printer), that can be evaluated separately. In general, there may be at least two, three, four or more features, such as from two to ten features. The opinion detection component 146 may be configured, for example, as disclosed in one or more of the following: application Ser. Nos. 13/052,774 and 13/052,686, M. Hu, B. Liu., “Mining and summarizing customer reviews,” ACM SIGKDD International Conf. on Knowledge Discovery & Data Mining (KDD-2004), Seattle, Wash. (2004); Bloom, K. Navendu G., Argamon S. “Extracting Appraisal Expressions,” Proc. HLT/NAACL, Rochester, USA (2007); Kim S-M, Hovy E., “Identifying and analyzing judgment opinions,” Proc. HLT/NAACL, New York (2006); and Caroline Brun, “Detecting Opinions Using Deep Syntactic Analysis,” Proc. Recent Advances in Natural Language Processing (RANLP), Hissar, Bulgaria (2011).

As noted above, in the exemplary system, there is a semantic mapping between the polar vocabulary term and the features it corresponds to: fast→speed, expensive→price, noisy, clunk→noise.

The system extracts opinion expressions using a set of opinion extraction patterns. These extraction patterns generally define terms that are in a syntactic relation. For example as one of the elements in the relation, an adjective or other polar term which is in the polar vocabulary 138 may be required to be in a syntactic relation with a term from one of the feature classes. For example, some extraction patterns relevant to adjectival terms (terms including an adjective, e.g., serving as a modifier or attribute) in the polar vocabulary 138 could be of the form:

If MODIFIER(noun X, modifier Y) and POLARITY(Z) extract NEGATIVE_OPINION (X).

This extracts an expression in the text 38 where a noun/noun phrase listed in a feature class X is modified by a modifier Y from the polar vocabulary with a given polarity Z, e.g., negative (or positive). Given the sentence “the scanner is slower than the one I had before” the system identifies the word “scanner” as being in the class “scanner speed” and the word “slower” as being in the polar vocabulary as a term of negative polarity. The word “slower” is also in a syntactic relation with scanner in which it acts as a modifier. The system then extracts a negative opinion expression NEGATIVE_OPINION (scanner speed) and stores it in the feature deficiencies 14.

As another example:

If ATTRIBUTE(noun X, attribute Y) and POLARITY(Z) extract NEGATIVE_OPINION (X)

This extracts an expression in the text 38 where a noun or noun phrase listed in a feature class X has an attribute Y Here attribute refers to a property of the noun) from the polar vocabulary with a given polarity Z, e.g., negative. As will be appreciated, further constraints may be placed on these rules. For instances of negation, similar rules may be provided:

If MODIFIER_NEG(noun X, modifier Y) and POLARITY(Z), or

If ATTRIBUTE_NEG(noun X, attribute Y) and POLARITY(Z)

extract NEGATIVE_OPINION (X)

where POLARITY (Z) is the reverse of the polarity in the examples above, e.g., positive in place of negative.

For example, given “the scanner is not faster than the one I had before”, the system extracts NEGATIVE_OPINION (scanner speed)

Some of the opinion mining rules may relate to nouns, pronouns, verbs, and adverbs Y which are in the polar vocabulary 138. These words and the rules which employ them may have been developed manually and/or through automated methods. For example rules relating to verbs might be of the form:

If SUBJECT(verb Y, noun X) and POLARITY(Z)

or,

If OBJECT(verb Y, noun X) and POLARITY(Z)

extract NEGATIVE_OPINION

where Y can be any verb from polar vocabulary of polarity measure Z (e.g., negative, and X can be a noun/noun phrase from any class X.

This could extract a negative opinion expression from “I hate the scanner speed” assuming “hate” is among the negative polar terms in the polar vocabulary.

Other methods for extracting opinion expressions which may be used in the method, are described, for example, in the references mentioned above, the disclosures of which are incorporated herein by reference.

When a rule identifies a semantic relation in the text 38 which includes a term in the polar vocabulary 138, it is flagged with the appropriate polarity, taking into account negation, as discussed above, which reverses the polarity. Each time such a negative opinion expression is identified, the system generates an item in the list 14.

Additionally or alternatively, the system may incorporate a suggestion detection component 148 for extraction of suggestions expressed in comments 38: The suggestion detection component 148 can be configured as described in copending application Ser. No. 13/272,553. In particular, the suggestion detection component 148 includes a set of suggestion pattern (grammar rules implemented on top of the parser output). Each suggestion pattern is designed for identifying suggestion expressions in the text 38, where each suggestion expression is expected to express a suggestion for improvement. The suggestions are extracted using the structured terminology 160, combined with specific extraction rules. A suggestion pattern is satisfied, in the text 38, when one of the features (i.e., one of the nouns/noun phrases in the terminology 160 listed for a given feature class) is found in a syntactic relation with a term which expresses a wish. The memory 126 may store a thesaurus 170 which includes a class of such wish terms, such as “hope”, “expect”, “wish,” etc., as well a class of terms expressing that something is lacking, such as “miss”, “lack”, etc. The parser may label instances of these terms in the text during the parsing stage. Each of the suggestion patterns may place constraints on the subject and/or predicate in the expression. Constraints on the predicate may include specifying that the subject of the sentence be in one or more of the feature classes in the structured terminology and/or the verb tense of the wish or lack term, the constraints having been developed to improve performance of the particular suggestion pattern.

For example, the semantic extraction component 12 may output the following information regarding the input sentences, extracted from customer reviews about printers:

Input:

“I think they should have put a faster scanner on the machine, one at least as fast as the printer.”→SUGGESTION_IMPROVE(scanner, speed).

The relation of “suggestion” is extracted using the following pattern: a terminological element of the target application domain, “scanner”, is the direct object of a modal verb used in the past tense, “should have put”: this is extracted as a suggestion of improvement. In extracting this suggestion pattern, the parser/semantic extraction component 12 may identify the term “faster” as relating to speed and identifies the expression (faster, scanner) as being in the list of the structured terminology 160 that relates to the feature Scanner Speed.

The extraction pattern also identifies “should have” as being a wish term in the thesaurus 170 and identifies that it is in a dependency with “scanner.” The extraction pattern thus identifies a suggestion for improvement which relates to the feature Scanner Speed and labels the text 38 accordingly. The extracted suggestion can then be added to the list 14 of extracted feature deficiencies for the review.

Input:

“I like this printer, but I think it is too expensive”→OPINION_POSITIVE(Printer,_), OPINION_NEGATIVE(printer,price).

These opinions may be extracted by applying the dedicated extraction patterns (rules) that are encoded within the parser/semantic extraction component. These rules combine a syntactic pattern together with opinion terms (positive or negative) encoded within the polar vocabulary 138. In this example, “like” is a positive term, “expensive” is a negative term. The rule extracting “OPINION_POSITIVE(Printer,_)” may be the following: If a linguistic unit is the direct object of a positive verb such as “like”, “love”, “appreciate”, etc. then there is a positive relation of opinion on the direct object (“printer”) as in “I like this printer”. Since printer is in the overall class of the structured terminology, the positive opinion is extracted. The rule extracting “OPINION_NEGATIVE(printer,price)” may be the following: If a linguistic unit is in attributive syntactic relation with a negative term in the polar vocabulary, there is a negative relation on it. Moreover, if this attribute semantically refers to a specific concept in the structured terminology (the word “expensive” is listed in the polar vocabulary as being negative, with respect to the feature Printer Price and here “expensive” is a negative term referring to “Printer Price”), the relation applies on the feature (“price”). In extracting this opinion pattern, the system identifies “it” as referring to printer, using coreference rules. As will be appreciated, a word or words of negation, such as in “not too expensive” would reverse the polarity of the opinion. The extracted opinion can then be added to the list 14 of extracted feature deficiencies for the review.

Input:

“The problem with this printer is the fuser”→OPINION_NEGATIVE(printer,fuser).

Here again the rule extracting “OPINION_NEGATIVE(printer,fuser)” is the following: If a linguistic unit that is in the structured terminology (“fuser”) is in attributive relation with a negative term (“problem”), there is a negative relation of opinion on it.

The extracted opinion can then be added to the list 14 of extracted feature deficiencies for the review.

### Retrieving Similar Items (S110)

In this step, attributes for each of a set of features are first identified for the reviewed item, including attributes of the deficient feature(s) identified in the feature deficiencies 14. Then, these attributes are compared with the attributes of a set of similar products.

In one embodiment, products of the same type may be stored in the same table of database 18. In more complex embodiments (for example, in the case of sparse data, millions of products) database tables can be split and views can be created by retrieving information from a set of tables. The database 18 can be populated manually and/or automatically through the websites that hold the product information. The database can be updated so that new items appear and old ones, e.g., products no longer available, are never recommended.

The database table 18 can include, for each of a plurality of products, and for each of a plurality of features, an attribute, such as a numerical value or other value which can be compared to other attributes for that feature on a scale of improvement (e.g., for a given feature A, attribute a1 is better than attribute a2, which in turn is better than attribute a3, and so forth).

For example, a relational database 18 stores feature attributes for each of a set of products. The database may include attributes for feature(s) corresponding to the identification information. The database access can be implemented similarly to electronic commerce software. Access can be permitted through SQL (Structured Query Language) queries (or using queries in any other suitable programming language designed for accessing data in a relational database).

The attributes of the reviewed product may be identified from a table of the database 18 using the extracted item identification information 30. For example a first SQL query could be generated which serves to “Find a record having an attribute for a feature A corresponding to identification information X.” Then, a second query is generated with the attributes of this record with a further requirement that at least for the deficient feature (or features), its attribute in one of the database items should be better than (an improvement over) that of the deficient feature of the reviewed item in order for that database item to be returned by the second query as an improved item. For example an SQL query could be generated which serves to “Find all products X with an attribute for feature A which is better than a, an attribute for feature B which is no worse than b, and an attribute for feature C which is no worse than c,” etc., where A, B, and C are the features for this type of item and a, b, and c are their values for the reviewed item, and feature A is the feature identified as being deficient. Worse than and better than are defined for each feature, as noted above.

The mapping component 142 is configured to retrieve products of the same general features. For example, it may be assumed that a user that has bought a personal printer will not need a recommendation for a professional one. The mapping component selects the items in the database whose features are within the same range of attributes as the reviewed product or in a “better” range. Product feature attributes that are considered important and should not change can be added in the query. For example, for the feature Printer Type, the query may specify that if the reviewed printer's attribute for this feature is a color printer, no monochrome printer should be proposed.

The attribute ranges can be defined in various ways and they can be subject to change. For example, in the case of the Price of Item feature, the attribute ranges may be based on the average price of the item or the product type in which it is classed. For example, if the average price of the item is $500, the prices of printers in the database may be quantized into ranges which increase by $50 or $100. Thus, a printer which costs $435 may be placed in a range of $400-$449, and printers in this range may be considered to be of equivalent price. In other embodiments, the ranges may be centered on the price of the item. Thus, in the case of the $435 printer, printers in the database costing $$410-$459 may be considered to be of equivalent price.

The mapping component generates a set of mapping criteria which are compared with the items in the database. Desirably, feature attributes for at least one (or all) of those features that are associated with a feature deficiency 14 at S108 should be in “better” range than the reviewed product, assuming that a database product with these feature attributes is available. For example, if the user has given an opinion that the $435 printer is too expensive or a suggestion that it could be cheaper, the system attempts to identify printers in a lower price range, while seeking to keep the other feature attributes within the same or better ranges. In some cases, the identified printer(s) may be in the same prince range, provided that they are cheaper. If it is not possible to identify a product which meets the mapping criteria, the mapping component may identify an item which fails to meet one of the feature's attribute ranges and the recommendation may make note of this. For example, it may state that “the XYZ printer is cheaper, but it has a slower scan speed.” In other embodiments, no recommendation is given if a product cannot be identified which is not at least equal with respect to all the attribute ranges and better with respect to the attribute of the feature deficiency.

Defining what a “better” range refers to depends on the feature. For example, in the case of price, the lower the price, the better it is, whereas, in the case of scan speed, the higher the speed the better it is. A table or an object-oriented class may be stored in memory that holds the order in which each feature is considered to be improved. For example, price has a descending order (e.g., denoted in the table by DESC) while scan speed has an ascending one (denoted by ASC).

In some embodiments, a minimum variation in the attribute (which may be expressed as a percentage or an amount) may be required for that feature to be considered improved. For example, for the price feature, a minimum variation in the attribute of $10 or $50 may be specified for desktop computers. This provides the reviewer with some assurance that they will not be presented with a recommendation for a computer that costs $5 less than the reviewed one, and which would likely not really be considered by the reviewer as “cheaper”.

The comparison between products can be considered as a comparison between objects and it can be achieved through the Comparable Java interface, Hibernate, etc.

In the case of more than one features in the feature deficiencies 14, priorities can be defined based on the order in which the features are mentioned in the review. For example, the mapping component may first attempt to identify products in which all the feature deficiencies are addressed and, if none exists, then attempts to identify products in which at least the first mentioned deficiency is addressed.

As will be appreciated, the exemplary system only addresses the case of features that are numeric or Boolean (e.g., presence/absence) and can be subjectively/objectively compared.

### Recommending the Items (S112)

Various possibilities exist for presenting items identified in S110 in the recommendation:

1. When many items are found to match the mapping criteria, more than one product can be recommended. A limit on the number of recommended products can be pre-defined and the products may appear to the user in the order of less-to-more expensive, or other suitable order which reflects the degree to which the feature deficiency is addressed.

2. In the case where no better answer is found within products of the same manufacturer or brand, then the recommendation may recommend products of a different brand/manufacturer. In some embodiments, the system may have the choice to remain “silent” and give no recommendation, which could be set by default or be a user-selectable option.

3. In the case where a better answer is found with respect to the feature deficiency but a non-demanded feature changes, the recommendation may provide information which identifies the change. For example, if a requested product is found but it is more expensive than the reviewed product, the recommendation may include some information regarding this feature (e.g., “A proposed product is” . . . “whose price, though, is higher”).

### Extensions

The system may be extended to include the user's knowledge (e.g., as an expert or a novice) in order to consider his suggestion/opinion from a different weighted-point-of-view. For instance, an expert may have already looked at existing products before buying something so that reviewer may be more interested in seeing recommendations for products that he is less likely to have considered, for example, products more recently released or products from a different manufacturer.

### EXAMPLES

For the purpose of the following examples, a sample database 18 table is considered that is specific to printers, as illustrated in TABLE 1. The features correspond to columns (fields) of the table. The records (rows) appear in ascending order of price. Each record is for a respective one of the printers and stores the attributes of each of the features (the attributes themselves or, in the case of a relational database, a key to another table in which the attributes are stored). For ease of reference, only a small set of features and example printers is considered, although it is to be appreciated that more of each may be included.

TABLE 1

| | | | | BLACK | | SCAN | |
|---|---|---|---|---|---|---|---|
| MFR | MODEL | USAGE | TYPE | SPEED | CAPACITY | SPEED | PRICE |
| AB Co. | Laser | Workgroup | Color Laser | 30 ppm | 1675 sheets | 20 ppm | $930 |
| | 100 | | | | | | |
| AB Co. | Laser | Workgroup | Color Laser | 42 ppm | 1250 sheets | 42 ppm | $754 |
| | 50 | | | | | | |
| AB Co. | Laser | Workgroup | Color Laser | 26 ppm | 300 sheets | 20 ppm | $750 |
| | 44 | | | | | | |
| AB Co. | Laser | All-in-one | Monochrome | 18 ppm | 650 sheets | 20 ppm | $747 |
| | 32 | | Laser | | | | |
| DE Co. | LAZ 20 | Workgroup | Color laser | 20 ppm | 300 sheets | 10 ppm | $350 |
| DE Co. | LAZ 30 | All-in-One | Monochrome | 19 ppm | 150 sheets | 14 ppm | $140 |
| | | | laser | | | | |

### Example A

S102: as input, a user's comments 38 within a review of the product “Laser 44 Printer” include the following text string (in this case a suggestion):

“I think they should have allowed for a higher capacity.”

S104 (retrieve manufacturer and model): AB Co., Laser 44 Printer is retrieved from the review.

S106, S108 (extract suggestions/opinions): SUGGESTION_IMPROVE(printer, capacity) is extracted.

S110 (find similar products) includes two steps:

a. identify attributes of reviewed item: workgroup, laser, color, 26 ppm black speed, 300 sheet capacity, §750 price.

b. Identify similar printers where capacity is higher (next range) than 300 sheets.

S112: Provide expert recommendation: “A proposed printer with a higher capacity is the AB Co. Laser 50 printer. The text “AB Co. Laser 50” may be hyperlinked to a product page describing that printer.

### Example B

S102 Input: User's opinion within a review of the product “Laser 44 Printer”:

“I like it but it is expensive!”

S104 (retrieve mfr. and model): AB Co., Laser 44 Printer.

S106, S108 (extract suggestions and opinions): OPINION_POSITIVE(Printer), OPINION_NEGATIVE(printer,price).

S110 (find similar products):

a. identify reviewed product's attributes: workgroup, laser, color, 26 ppm black speed, 300 sheet capacity, $750 price

b. identify similar printers where price is lower than $750.

S110: Expert recommendation: “A proposed cheaper printer of the same type is a DE Co. Jet 20”. The text “DE Co. Jet 20” may be hyperlinked to a product page describing that printer.

Advantages of the system in various embodiments may include the following:

It makes use of written opinions and suggestions (i.e., fine-grained information about product features) extracted from user's reviews as input to a recommender system. This kind of opinion extracted from the Web (e.g., review sites) is analyzed from a syntactic and semantic point of view and can be used as a means to recommend items that are an improvement over the reviewed one, at least with respect to features whose attributes are identified as being deficient.

A product comparison is included in the recommendation process which is not limited to finding similar products/items but extends to finding better (regarding certain features) ones.

It enables using the explicit comments of a user in order to enrich the reviews in a contextual manner, as the recommendations are adapted to the content of the comments.

It allows recommendations to be provided to customers based on their explicit opinions or suggestions.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for generating recommendations comprising:
receiving a user's review of an item which includes a textual comment;
applying a set of extraction patterns to the textual comment, each of the extraction patterns being configured to identify a deficient feature of the item based on a finding of a specified syntactic relation between words of the textual comment;
providing for when a deficient feature is identified:
identifying an attribute of each of a plurality of features for the reviewed item, the plurality of features including the identified deficient feature;
comparing the identified attributes of the reviewed item with stored attributes for the plurality of features for items in a set of items to identify an improved item from the set of items which has an attribute for the deficient feature which is determined to be an improvement over the attribute of the deficient feature for the reviewed item; and
generating a recommendation for the identified improved item.

2. The method of claim 1, wherein at least one of the identifying of the deficient feature, identifying of attributes, comparing, and generating is performed with a computer processor.

3. The method of claim 1, comprising providing a structured terminology which, for each of the features in the set, includes a set of associated terms, the at least one extraction pattern being configured for identifying the specified syntactic relation between one of the associated terms and another term in the textual review, the deficient feature being identified as the feature with which the associated term is associated.

4. The method of claim 3, wherein at least one of the extraction patterns is configured for identifying a negative opinion of the item from the textual review, wherein the other term in the extraction pattern being found in a polar vocabulary which assigns a polarity to each of a set of polar terms.

5. The method of claim 1, wherein at least one of the extraction patterns is configured for identifying a suggestion of improvement for the item from the textual review.

6. The method of claim 5, wherein the other term in the extraction pattern is found in a thesaurus of terms relating to at least one of a lack and a wish.

7. The method of claim 1, wherein the identification of the attributes of the reviewed item comprises extracting, from the review, item identification information for the reviewed item and wherein the identification of the attributes of the reviewed item are identified based on the item identification information.

8. The method of claim 1, wherein the comparing of the identified attributes of the reviewed item with the stored attributes for the set of items comprises identifying items which have attributes which match the respective attributes of the reviewed item, and wherein the identified improved item has an attribute for the deficient feature which is better than the attribute of the deficient feature for the reviewed item.

9. The method of claim 8, wherein the identifying items which have attributes which match the respective attributes of the reviewed item comprises, for at least one of the features other than the deficient feature, identifying items which have a respective attribute which is in a same range as the attribute of the reviewed item.

10. The method of claim 1, wherein the generating a recommendation for the identified improved item comprises adding, to the review, a link to a description of the improved item.

11. The method of claim 1, wherein the item comprises a product or service.

12. The method of claim 1, wherein the item comprises a non-transitory product.

13. A system comprising memory which stores instructions for performing the method of claim 1 and a processor, in communication with the memory, for executing the instructions.

14. A computer program product comprising a non-transitory recording medium storing instructions, which when executed on a computer, causes the computer to perform the method of claim 1.

15. A system for generating recommendations comprising:
a semantic extraction component configured to identify a deficient feature of a reviewed item from a textual comment in a user's review of the item using a set of extraction patterns, each of the extraction patterns configured for identifying a specified syntactic relation between words of the textual comment;
a mapping component configured to query an associated database with attributes of the reviewed item for identifying improved items, the associated database including, for each of a set of items, attributes for each of a set of features, the set of features including the identified deficient feature, each of the identified improved items having an attribute which is determined to be better, for the deficient feature, than the attribute of the reviewed item;
a recommendation generator configured to generate a recommendation for the identified improved item; and
a processor which implements the semantic extraction component, mapping component, and the recommendation generator.

16. The system of claim 15, further comprising a structured terminology stored in memory which, for each of the features in the set, includes a set of associated terms, at least one of the extraction patterns being configured for identifying when one of the associated terms from the structured ontology is in the specified syntactic relation, the deficient feature being identified as the feature with which the associated term is associated.

17. The system of claim 15, further comprising a polar vocabulary stores in memory which assigns a polarity to each of a set of polar terms and wherein at least one of the extraction patterns specifies that the syntactic relation includes one of the terms from the polar vocabulary.

18. The system of claim 15, further comprising a thesaurus of terms relating to wish or lack stored in memory and wherein at least one of the extraction patterns specifies that the syntactic relation includes one of the terms from the thesaurus.

19. The system of claim 15, wherein the semantic extraction component comprises an opinion detection component which applies extraction patterns for detecting negative opinions about features of reviewed items and a suggestion extraction component which applies extraction patterns for detecting suggestions for improvement in features of reviewed items.

20. A method for generating recommendations comprising:
receiving a user's review of an item which includes a textual comment;
applying extraction patterns to the textual comment, each of the patterns being satisfied when a first term in a textual comment is in a syntactic relation with a second term in the textual comment, the first term being associated in memory with one of a set of features, the second term comprising a term from a polar vocabulary or an expression of a wish or a lack;
when one of the extraction patterns is satisfied, identifying the associated feature as a deficient feature of the reviewed item;
comparing feature attributes of the reviewed item with feature attributes of items stored in a database to identify an item in the database for which the feature attribute for the feature identified as deficient in the item is an improvement; and
generating a recommendation based on an identified improved item.
